(19) United States
(12) Patent Application Publication
(10) Pub. No.: US 2024/0130569 A1
(43) Pub. Date: Apr. 25, 2024

(54) MIXER

(71) Applicant: WAYNE FROMM, Toronto (CA)

(72) Inventor: WAYNE FROMM, Toronto (CA)

(21) Appl. No.: 18/220,219

(22) Filed: Jul. 9, 2023

Related U.S. Application Data
(63) Continuation-in-part of application No. 17/969,657, filed on Oct. 19, 2022.

(51) Int. Cl. A47J 43/08; A47J 43/07

(52) U.S. Cl. CPC A47J 43/082; A47J 43/0755; A63H 3/003

(57) ABSTRACT

A child-friendly mixing apparatus for mixing various food substances is disclosed. The mixing apparatus includes a container with an opening, a lid that fits into the opening, and a mixing assembly. The lid includes a centrally located hole that has shaped sides. The mixing assembly includes a housing, a motor within the housing, a mixing attachment that is rotated by the motor, and at least one button that turns the motor on and off. The housing may have a substantially flat top. The mixing attachment fits through the lid hole and the lower end of the mixing assembly rests against the shaped sides of the lid hole. The mixing attachment may include fins to prevent breakage when it is removed from the container. The button is located on the portion of the mixing assembly that rests against the curved sides of the lid hole, and is actuated when the mixing assembly is put in its operating position and a small downward force is applied. A mixing kit is also disclosed, the mixing kit including a straw adapter and a measuring spoon in addition to the mixing apparatus.

### CROSS-REFERENCE TO RELATED APPLICATIONS

The present application is a continuation-in-part of U.S. patent application Ser. No. 17/969,657, entitled “MIXER,” filed Oct. 19, 2022, which is incorporated by reference herein in its entirety.

### BACKGROUND

This specification relates generally to food processors and more specifically to mixers easily usable by children. Various types of mixers are known in the art, such as electric powered hand mixers, stand mixers, and others. Some toy mixers are also found in the art. For example, U.S. Pat. No. 3,774,338 discloses a crank-activated toy blender and percolator. The '338 patent, however, does not use electricity, and requires significant manual dexterity to operate.

Frothers, which are devices configured to add air bubbles to a liquid, are also known in the art. Prior art electric frothers are typically hand-held devices that include a motor, an on/off switch, and a frothing element. When the frother is turned on, the motor rotates the frothing element, adding air bubbles to the liquid. An alternative prior art frother (e.g., U.S. Patent Publication No. 2019/0216257 to Lui et al.) incorporates air into the liquid through injection of steam.

However, the mixers and frothers in the art are generally not child friendly, in that they require manual dexterity (e.g., in holding steady a hand mixer or frother while the motor is running), constant physical pressure on a button or other element (e.g., pushing a button to activate the mixing or frothing motion, such as the rotation of the frothing element), and/or A/C power. Some mixers and frothers may be dangerous for children to operate, because of the use of steam, rapidly spinning blades, sharp blades, wire whisk blades that can splinter, etc.

There remains a need for a child-friendly mixer that is easy to use, does not require significant manual dexterity or constant pressure, and is battery-powered to prevent risk of electric shock. It would be beneficial if the mixer is capable of mixing a wide variety of ingredients, including, e.g., liquids (e.g., milk, water, juice, etc.), flavored powders, dairy products (e.g., yogurt, ice cream, whipped topping, etc.), non-dairy milks (e.g., plant-based milks, such as almond or soy milk), non-dairy yogurts, non-dairy frozen products, fruits, sprinkles and other mix-ins, etc., and of frothing various liquids.

### SUMMARY

In accordance with the foregoing objectives and others, exemplary mixers are disclosed herein that are child-friendly and do not require the user to apply manual pressure to any element of the mixer.

One embodiment is directed to a mixing assembly comprising: a housing configured to interface with a hole in a lid of a container; a motor disposed within the housing; a power source configured to provide power to the motor; a switch for controlling the motor, the switch disposed on the housing; and a mixing element directly or indirectly attached to the motor, wherein the mixing element is sized to fit through the hole in the lid; wherein the switch is disposed on the housing in a location that causes the switch to be actuated when the mixing assembly interfaces with the hole in the lid and force is applied to the mixing assembly.

An additional embodiment is directed to a mixing assembly comprising a housing; a motor disposed within the housing; a pressure switch for controlling the motor, the switch disposed on a lower end of the housing; and a mixing attachment directly or indirectly attached to the motor, the mixing attachment comprising at least one agitator; wherein the agitator is designed and dimensioned to be inserted into a container through a hole in a lid of the container, and to facilitate easy removal of the mixing assembly from the container through the hole; wherein the mixing attachment is configured to substantially reduce the risk of damage to the agitator when the mixing assembly is removed from the container.

A further embodiment is directed to a mixer kit comprising: either of the mixing assemblies recited above; a container and a lid for the container, the lid comprising a hole; a straw adapter, the straw adapter configured to fit into the hole of the lid of the container, the straw adapter comprising a centrally located hole sized to fit a conventional straw; and a measuring spoon sized to fit into the hole of the lid of the container to deposit measured powder or liquid portions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an embodiment of a mixer in an operational position.

FIG. 2 illustrates an embodiment of a container and lid of a mixer.

FIG. 3 illustrates an additional view of an embodiment of a lid of a mixer.

FIG. 4 illustrates a cutaway view of an assembled container and lid.

FIG. 5 illustrates an embodiment of a mixing assembly.

FIG. 6 illustrates an exploded view of a mixing assembly.

FIG. 7 illustrates an alternative embodiment of a container and a lid.

FIG. 8 illustrates an embodiment of a straw adapter.

FIG. 9 illustrates an embodiment of a measuring spoon.

FIGS. 10 and 11 illustrate an embodiment of a combined mixing attachment.

FIG. 12 illustrates an embodiment of a housing.

FIG. 13 illustrates a cutaway view of an assembled container and lid.

FIG. 14 illustrates an embodiment of a mixer in an operational position.

### DETAILED DESCRIPTION

Various embodiments are disclosed herein to provide a mixer that uses the force of gravity to help operate the mixer when the parts of the mixer are in an operational position. Unlike conventional mixers, the disclosed mixers reduce the need for application of manual pressure to operate the mixer, while still remaining easy to use and safe for children. The disclosed mixers are also impact and shatter-resistant, and prevent breakage of the mixing attachment when the mixing assembly is removed from the container.

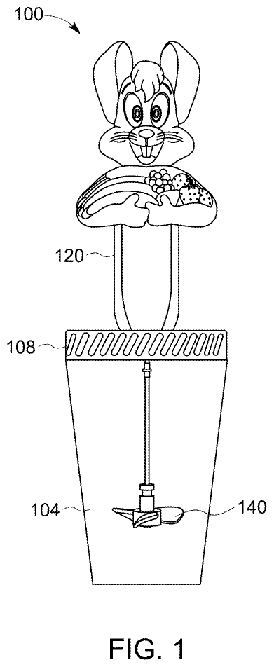

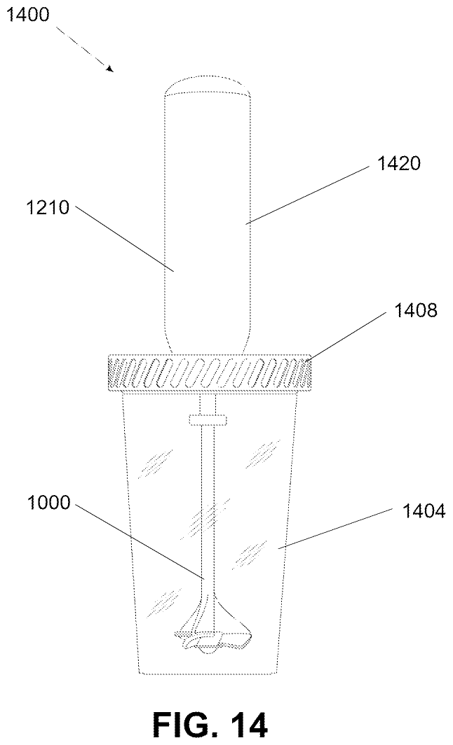

As used herein, bottom and top and lower and upper refer to the normal operating position of the mixer, e.g., as illustrated in FIGS. 1 and 14. In the following disclosure, examples of mixing drinks are primarily used, but the mixer may be used to mix other types of food substances, for example puddings, dairy products (e.g., ice cream and yogurt), non-dairy yogurts, non-dairy frozen products, etc. The mixer may also be used to froth liquids and even mix non-food substances. However, in preferred embodiments all materials are food safe.

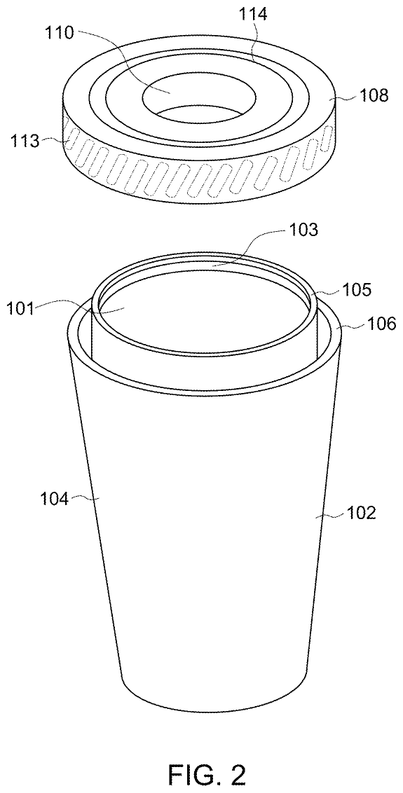

Referring now to FIGS. 2 through 4, one embodiment of a mixer 100 is illustrated. The mixer includes a container 104, a lid 108, and a mixing assembly 120. The container is roughly cylindrical in shape, with the top of the container having a larger diameter than the bottom. The bottom of the container is closed and shaped to enable the container to rest on a substantially flat surface. The top of the container 104 is open. In an embodiment, the container is primarily or mostly cylindrical. In an alternative embodiment, the top of the container has a larger diameter than the bottom, giving the container a partly conical shape.

The container 104 has an inside surface 101 and an outside surface 102. In an embodiment, the upper part of the inside surface 101 includes a threaded portion 103 for securing the lid 108 thereto. The lid 108 includes a matching threaded portion 109.

In a particular embodiment, the container 104 has an inner wall 105 and an outer wall 106, which (as best seen in FIG. 4) merge together about halfway down the height of the container. In this embodiment, the threaded portion 103 is disposed on the inside surface of the inner wall 105.

The lid 108 is roughly disc-shaped, and includes a threaded edge 109 and a hole 110. The lid 108 is sized to accommodate a secure seal between the container and the lid. The fit of the lid to the container is secure enough to prevent the escape of food particles and/or liquids during normal use of the mixer. In an embodiment, the outer edge 113 of the lid may be textured (e.g., it may have grip lines) or may include a grip mold to aid the user in gripping.

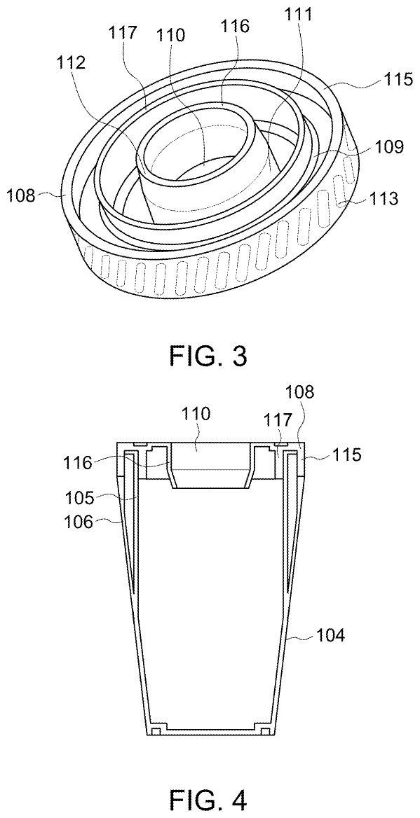

In an alternative embodiment, the lid may be a snap-on flexible lid. As above, the lid is configured to accommodate a food-secure seal between the container and the lid Marshalled though the middle of the lid 108 is a hole 110 sized to accommodate various food powders, such as drink mixes, pudding mixes, etc. The hole 110 is also sufficiently large in diameter to enable the pass-through of mixing attachment 140. As best seen in FIGS. 3 and 4, the hole may have curved and/or sloped sides. In an embodiment, the sides of the hole comprise two sections, an upper section 111 and a lower section 112. The upper section 111 and lower section 112 may be sloped or curved at various angles or curvatures to provide an interface for the lower end 127 of the mixing assembly housing 124.

Alternatively, the sides of the hole 110 may be any other shape that provides for an interface with the lower end of the mixing assembly housing, so that the mixing assembly is held in place during operation. For example, square, triangular, angular, etc.

In a particular embodiment, the lid 108 comprises a roughly circular upper disc 114 with a centrally-located hole 110. Extending downward from the disc 114 are three cylindrical walls, an outer wall 115, an inner wall 116, and an intermediate wall 117. The inner wall 116 includes an upper section 111 and a lower section 112, which may be sloped or curved at various angles or curvatures. The lower section 112 is angled more inward (toward the hole 110) than then upper section 111, providing a structure on which the housing 124 of the mixing assembly 120 rests.

In this embodiment, the threaded portion 109 is disposed on the intermediate wall 117 on its outside surface. Further, the outside surface 113 of the outer wall 115 includes a textured surface and/or a grip mold for ease of handling. The outer and intermediate walls (115, 117) extend downwards a sufficient length to interface with the outer wall 106 and inner wall 105 of the container 104, respectively.

The container and lid may be made of any suitable material, e.g., food-safe plastic, etc. In an embodiment, the material may be impact- and/or shatter-resistant. In an embodiment, the container may be transparent or substantially translucent for easy viewing of the mixing process.

FIG. 4 illustrates a cutaway view of the lid 108 and container 104 assembly, where the lid 108 is screwed in place.

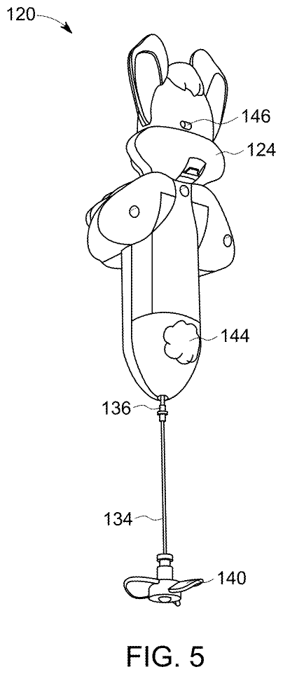

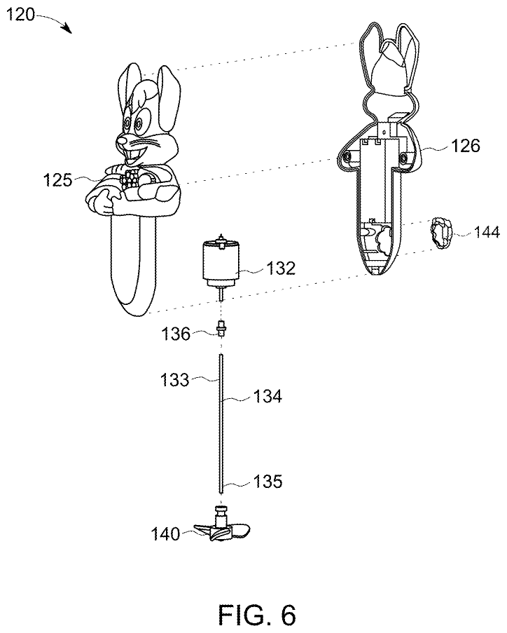

FIGS. 5 and 6 illustrate assembled and exploded views respectively of a mixing assembly, The mixing assembly 120 includes a housing 124, a power source (not shown), a motor 132, a rod 134, a mixing attachment 140, an activation switch 144, and an optional on/off switch 146.

The housing 124 may be separated into two or more pieces (125, 126) for ease of manufacturing and/or assembly. If so, the pieces may be joined using any suitable attachment means, e.g., screws, glue, etc. The housing may be made of any suitable material, e.g., plastic. In an embodiment, the housing may be made of an impact- and/or shatter-resistant material.

In an embodiment, the housing 124 may be formed in a kid-friendly shape, e.g., an animal (e.g., a rabbit, reptile, dinosaur, etc.), an insect (e.g., butterfly, ladybug, etc.), an anthropomorphic animal, a mythological creature (e.g., a unicorn, etc.), a cartoon or comic character, a fantasy character (e.g., a wizard), a sports player, a non-sports celebrity, an object related to sports (e.g., football, etc.), various types of foods (e.g., vegetables, fruits, etc.), etc. Any shape that may be of interest to children is contemplated to be within the scope of this invention.

The power source drives the motor 132, and may comprise a battery (e.g., alkaline), rechargeable battery (e.g., lithium ion, lithium ion phosphate, etc.), or other portable power source. The battery is preferably located in the lower section 127 of the housing 124 to lower the center of gravity of the mixing assembly, which helps balance the mixing assembly during operation.

The rod 134 comprises a first end 133 and a second end 135. The first end 133 is configured to attach to the motor, directly or indirectly (e.g., using an adapter 136). The rod may be made of any suitable material, e.g., metal, plastic, etc., and is sized to place the mixing attachment 140 at the desired position in the container 104. In a particular embodiment, the rod may be a plastic-coated metal (e.g., steel) rod.

In an embodiment, the desired position of the mixing attachment may be based on the amount of cyclonic action the mixing attachment induces during operation between the bottom of the mixing attachment and the bottom of the container, e.g., sufficient cyclonic action to mix liquids, puddings, dairy products (e.g., ice cream and yogurt), non-dairy yogurts, non-dairy frozen products, etc. In a particular embodiment, the position of the mixing attachment may be approximately 15 mm to approximately 25 mm above the bottom of the container (measured between the bottom of the container and the bottom of the mixing attachment). In a more particular embodiment, the position of the mixing attachment may be approximately 20 mm above the bottom of the container.

The mixing attachment 140 is attached to the second end 135 of the rod 134, and may comprise a frother, a beater, an agitator, a paddle mixer, or any other type of attachment that can be used for mixing. The mixing attachment may be made of any suitable material, e.g., metal, plastic, rubber, etc. The mixing attachment may be removable from the rod to enable switching of attachments for various mixing tasks. Generally, the mixing attachment is sized to fit though the lid hole 110. In an embodiment, the mixing attachment may be sized to reach the inside walls of the container when the mixing assembly is in an operational position.

In an embodiment, the rod 134 and mixing attachment 140 are removable from the mixing assembly for convenient cleaning and replacement.

In an embodiment, the rod 134 and mixing attachment 140 are combined into a single element. In another embodiment, the rod 134, mixing attachment 140, and adaptor 136 are combined into a single element. In any of these embodiment, the single combined element may comprise any suitable material, e.g., metal, plastic, plastic-coated metal, rubber or silicone coated metal, etc.

The activation switch 144 is configured to turn the motor 132 on and off. In an embodiment, the activation switch may be any type of switch that can be activated through the application of pressure, e.g., a pushbutton switch, a pressure switch, a friction switch, etc. When sufficient pressure is applied to the switch 144, the motor 132 will be activated. The amount of pressure required to actuate the switch 144 may be configured to be substantially similar to or slightly greater than the amount of pressure applied to the switch 144 when the mixing assembly is in an operational position, thus allowing the motor 132 to be turned on by inserting the mixing attachment of the mixing assembly through the lid hole 110 and placing the lower end 127 of the housing against the sides of the lid hole and applying a slight amount of pressure, e.g., the amount of pressure a child could easily apply. In an embodiment, no additional pressure is necessary—the gravitational force alone is enough to turn on the motor. The switch 144 may be positioned anywhere on the housing 124 that interfaces with the lid 108 of the container 104 when the mixing assembly is in an operational position, such that the lid applies pressure to the switch 144.

In an embodiment, the switch 144 is configured to be water resistant. For example, it may be protected by a water-resistant membrane.

Alternatively, the activation switch 144 may be a light sensitive switch that activates when the switch is covered, or a magnetic switch that is engaged when in proximity to a magnetic field, such as may be produced by a magnet (or other source of a magnetic field) disposed within the sides of the lid hole.

The on/off switch 146 is configured to turn the motor 132 on and off, and may comprise any type of switch, e.g., a pushbutton switch (preferably located in the upper end of the housing 124), a recessed pushbutton switch, a sliding switch, etc. In an embodiment, the on/off switch may be an internal rotational switch, which is activated by rotation of a portion of the housing. In such an embodiment, the housing may comprise additional sections for ease of assembly.

The on/off switch 146 (if present) and the pressure or friction switch 144 control the operation of the motor in a conventional manner. In an embodiment, the motor will only activate if both switches are actuated. This enables a user to prevent accidental activation of the motor, e.g., when the mixing assembly is placed in a kitchen drawer for storage. For example, when in storage, the on/off switch may be set to the ‘off’ position, so if the pressure switch 144 is pressed, the motor will not activate. The on/off switch can be set to ‘on’ when the mixer is being used.

If the on/off switch is not present, the pressure switch 144 may be configured to have a mechanical locking mechanism. In on such embodiment, the pressure switch 144 is round, and can be rotated to mechanically lock the switch, e.g., to prevent it from being pressed and thus activating the motor 132. In this embodiment, the pressure switch can be set to the locked position prior to storage.

The lower end of the housing 127 has shaped sides that interface with the sides of lid hole 110, but may also allow for some pivoting movement, e.g., to allow the mixing element to be pivoted to allow the mixing attachment to reach the sides of the container.

The mixer of the disclosed embodiments may be used with a variety of items, such as off the shelf flavored drinks, e.g., powdered flavored milk mixes, mixed with milk, water or another liquid; pudding mixes mixed with liquid; fruit juices; etc. With the appropriate mixing attachment, e.g., a frother, the disclosed mixer may also be used to add air bubbles to a liquid such as milk.

In operation, a user puts the lid 108 on the container 104 and pours items to be mixed (e.g., drink powders, pudding mixes, liquids, whipped topping, sprinkles, etc.) through the lid hole 110. The user then inserts the mixing attachment of the mixing assembly through the lid hole 110 and rests the lower end of the mixing assembly housing 124 on the lid hole sides, which as described herein are shaped in a manner to hold the lower end of the housing. When the mixing attachment is in the operational position and a small amount of downward pressure is applied, the pressure switch 144 is actuated, causing rotation of the mixing attachment and thereby mixing the contents of the container. The shape of the lid hole sides 110, and the corresponding shape of the lower end of the housing 124, may enable the mixing assembly to be pivoted and/or rotated to aid in the mixing process. The disclosed mixer is easy for a child to use and achieve satisfying results, and will encourage independence.

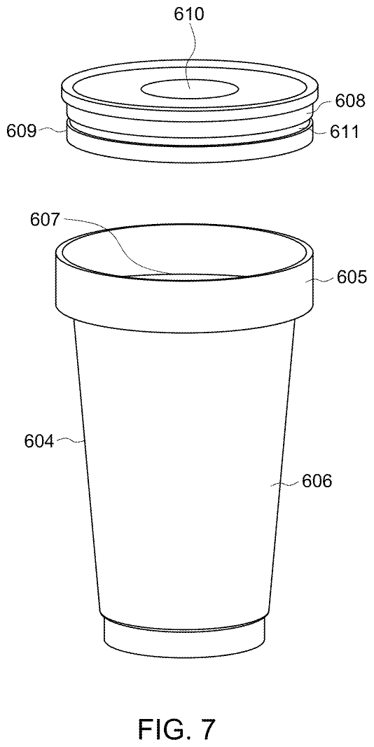

An alternative embodiment of the container is illustrated in FIG. 7, with the container having sloping sides. The container 604 comprises an upper portion 605 and a lower portion 606. The lower portion 606 has sloping sides, with the bottom having a smaller diameter that the top. The sides of the upper portion 605 are substantially straight. Also, the upper portion 605 of the container protrudes outward from the lower portion 606, on both the inside and the outside, creating a ledge 607 on which the lid 608 rests.

The lid 608 is roughly disc-shaped, and includes an outer edge 609 and a hole 610. The lid 608 is sized to enable the outer edge of the lid to securely fit to the top of the container 604, creating a friction seal. The fit of the lid to the container is secure enough to prevent the escape of food particles and/or liquids during normal use of the mixer.

In an embodiment, the lid outer edge 609 includes a groove 613 around its circumference. The groove is sized to accommodate a rubber seal or gasket (e.g., a O-ring, etc.) to aid in providing a secure fit between the lid and the container.

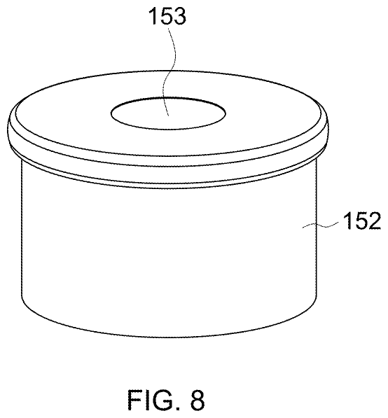

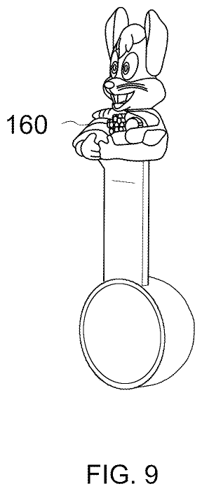

In an embodiment, the mixer may be provided to a user as part of a mixer kit. An example mixer kit includes the mixing assembly 120, the container 104, the lid 108, a straw adapter 152 as illustrated in FIG. 8, and a measuring spoon 160 as illustrated in FIG. 9. The measuring spoon 160 is sized to fit into the lid hole 110, and may be used to measure powders or liquids in appropriate quantities for mixing. The mixer kit may also include molds that can be used to make frozen treats.

The straw adapter is configured to fit in the lid hole 110, and has a centrally-located hole 153 that is sized to accommodate a straw. After the drink is sufficiently mixed, the user can remove the mixing assembly 120 from the lid and insert the straw adapter 152 into the lid hole 110. A straw can then be inserted into the straw hole 153 to ingest the mixed beverage. Alternatively the mixed liquid can be poured into separate containers and refrigerated to form a pudding or placed in a freezer to make frozen treats.

While specific embodiments of a mixer have been disclosed herein, one of ordinary skill in the art will recognize that variations on the disclosed embodiments may be used for the same purpose. For example, the power source may also comprise an A/C adapter. Other variations have been discussed above.

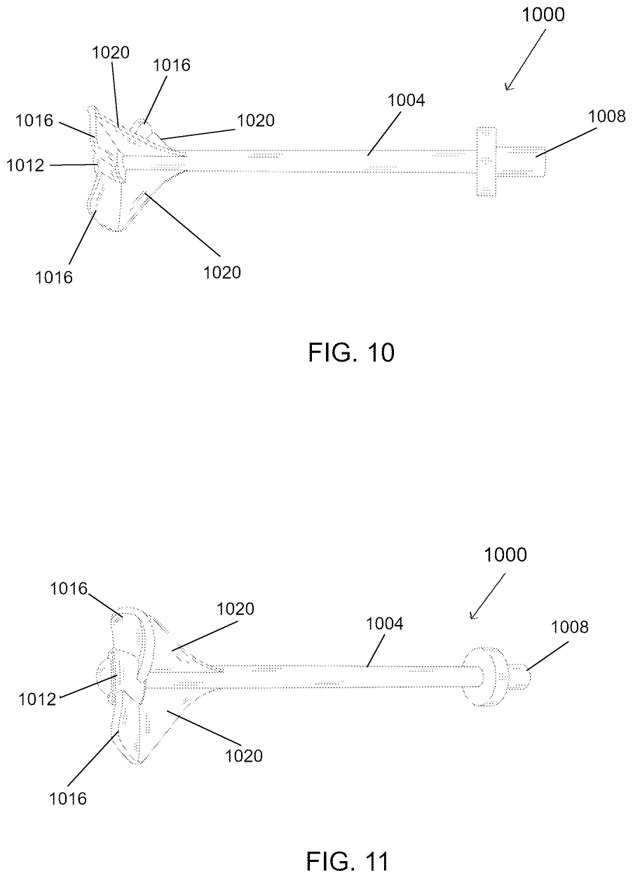

An alternative embodiment of a mixing attachment 1000 is illustrated in FIGS. 10 and 11. In this embodiment, the mixing attachment 1000 comprises a rod portion 1004, an adaptor portion 1008, a terminal portion 1012, one or more blades 1016 and one or more fins 1020. The adaptor portion is configured to interface with the motor 132 as described elsewhere herein. The rod portion is sized to place the terminal portion 1012, including the blades 1016 and the fins 1020, at the desired position within the container 104. The terminal portion has a cylindrical shape with a larger radius than that of the rod portion, and is the base for the attachment of the blades.

In an embodiment, the desired position of the mixing attachment may be based on the amount of cyclonic action the mixing attachment induces during operation between the bottom of the mixing attachment and the bottom of the container, e.g., sufficient cyclonic action to mix liquids, puddings, dairy products (e.g., ice cream and yogurt), non-dairy yogurts, non-dairy frozen products, etc. In a particular embodiment, the position of the mixing attachment may be approximately 15 mm to approximately 25 mm above the bottom of the container (measured between the bottom of the container and the bottom of the mixing attachment). In a more particular embodiment, the position of the mixing attachment may be approximately 20 mm above the bottom of the container.

Each blade 1016 extends out from the terminal portion 1012, and may be curved. The blades are configured to be safe when coming in contact with human skin (e.g., a child's skin), even when being rotated by the motor 132. For example, the blades may be curved in such a manner as to limit irritation when in contact with the user's skin. The edges of the blades may also be shaped to limit irritation, e.g., there may be no sharp corners.

In FIGS. 10 and 11, the blades are spaced equidistant around the terminal portion 1012. However, alternative blade arrangements are contemplated to be within the scope of the present disclosure.

Each blade has an associated fin. Each fin is roughly triangular, with the fin projecting from the top surface of the blade upwards along the rod portion 1008. In an embodiment, each fin is relatively narrow in width, and the outside edge of each fin is curved slightly inward.

The fins serve to prevent the blades from catching on the sides of the opening 110 and possibly breaking when the mixing assembly is removed from the container. Other arrangements of blades and fins for the mixing attachment may be used to provide the same functionality. For example, the fins may have a different curvature or radius on their outside edge. The fins may extend upwards along the rod portion a different length, or have a different width. All particular arrangements of blades and fins that enable easy removal of the mixing attachment while preventing breaking of the mixing attachment are contemplated to be with the scope of this disclosure.

Alternative embodiments of the mixing attachment that limit or prevent breakage of the mixing attachment are also considered to be within the scope of this disclosure, e.g., mixing attachments with flexible elements, mixing attachments made with resilient materials, etc.

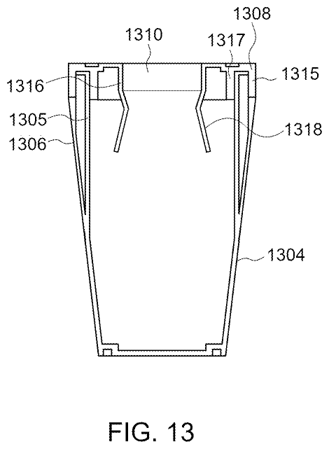

FIG. 13 shows an alternative embodiment of the container 1304 and lid 1308 that serves to limit or prevent breakage of the mixing attachment when it is removed from the container after use. The container includes inner wall 1305 and outer wall 1306.

The lid includes a hole 1310, an outer wall 1315, an intermediate wall 1317, and an inner wall 1316. The inner wall 1316 includes a flared portion 1318. The flared portion has a radius that increases towards the bottom of the inner wall 1316. The wider radius at the bottom of the inner wall enables the user to remove the mixing attachment without breaking the blades or other elements of the mixing attachment, as there is a larger opening for the mixing attachment to enter. In an embodiment, the flared portion may extend all the way to the inner wall 1305 of the container to make it even easier for the user to remove the mixing attachment without risk of breaking.

In some embodiments a combination of the above breakage-prevention elements may be used. For example, mixing attachment fins may be combined with the flared inner wall of the lid to further limit the risk of breakage. All such combinations that serve to limit the risk of breakage of the mixing attachment are contemplated to be within the scope of the claimed invention.

The fins also provide additional agitation to the liquids during the mixing process. The exact shape and size of the blades and fins may also be configured to provide desired mixing characteristics.

The adapter portion, rod portion, terminal portion, blades, and fins may be made of any suitable material, e.g., metal, plastic, rubber, etc. Additionally, the adaptor portion, rod portion, terminal portion, blades, and fins may be made from different materials, e.g., the blades may be made of plastic and the fins made of rubber, though for ease of manufacturing, the elements will generally be made of the same material. In an embodiment, the elements may be separable from each other.

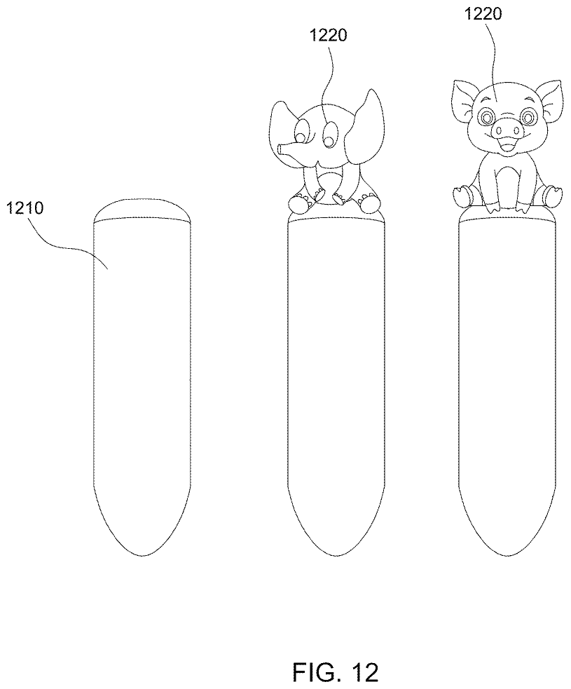

FIG. 12 illustrates an additional embodiment of a housing. In the embodiment shown in FIG. 12, the housing 1210 may be primarily cylindrical in shape with a substantially flat top surface that enables the mixer assembly to stand upside down when not in use. This makes it convenient to dry the mixing attachment after use.

In this embodiment, the top surface of the housing may include one or more connectors to allow the attachment of a collectible figurine (or other object) 1220. The figurine (or other object) includes a matching connector on its underside. The figurine (or other object) allows customization of the mixer, e.g., in families where more than one mixer may be owned.

The connector may comprise any type of connector, e.g., a reusable sticky substance (e.g., polyurethane gel), a magnet in combination with a ferromagnetic metal, male and female fittings, clips, etc.

FIG. 14 illustrates an additional embodiment of a mixer 1400. The mixer 1400 includes a container 1404, a lid 1408, and a mixing assembly 1420, which comprises the mixing attachment 1000 and the housing 1210 described above. The container 1404 is roughly cylindrical in shape, with the top of the container having a larger diameter than the bottom. The bottom of the container is closed and shaped to enable the container to rest on a substantially flat surface. The lid 1408 is substantially as described elsewhere in this application.

Various embodiments are described in this specification, with reference to the details discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one of ordinary skill in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those of ordinary skill in the art, and such modifications are also intended to fall within the scope of the claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All references including patents, patent applications, and publications cited herein are incorporated by reference in their entirety and for all purposes to the same extent as if each individual patent, patent application, or publication was specifically and individually indicated to be incorporated by reference in its entirety for all purposes.

What is claimed is:

1. A mixing assembly comprising:
a housing configured to interface with a hole in a lid of a container;
a motor disposed within the housing;
a power source configured to provide power to the motor;
a switch for controlling the motor, the switch disposed on the housing; and
a mixing element directly or indirectly attached to the motor, wherein the mixing element is sized to fit through the hole in the lid;
wherein the switch is disposed on the housing in a location that causes the switch to be actuated when the mixing assembly interfaces with the hole in the lid and force is applied to the mixing assembly.

2. The mixing assembly of claim 1, wherein the housing is configured in a primarily cylindrical shape.

3. The mixing assembly of claim 2, wherein the housing comprises a top, and the top of the housing is substantially flat.

4. The mixing assembly of claim 3, wherein the top of the housing comprises a connector.

5. The mixing assembly of claim 1, wherein the housing comprises at least a first end, wherein the first end is configured to interface with the hole in the lid, wherein the first end comprises a portion that interfaces with a side of the hole in the lid.

6. The mixing assembly of claim 5, wherein the switch is disposed on the portion of the first end that interfaces with the side of the hole in the lid.

7. The mixing assembly of claim 6, wherein the switch is a push-button switch.

8. The mixing assembly of claim 7, wherein the pressure required to actuate the push-button switch and the weight of the mixing assembly are configured so as to cause the switch to be actuated when the mixing assembly and the container are in an upright position, the first end of the mixing assembly is interfaced with the hole of the lid, and a small downward force is applied to the mixing assembly.

9. The mixing assembly of claim 1, wherein the switch is configured to be water-resistant.

10. The mixing assembly of claim 1, wherein the mixing element comprises a rod and a mixing attachment, the rod comprising a first end and a second end, the first end configured to directly or indirectly connect to the motor, the second end configured to connect to the mixing attachment.

11. The mixing assembly of claim 10, wherein the mixing attachment comprises one or more blades.

12. The mixing assembly of claim 11, wherein the mixing attachment further comprises one or more fins extending upwards from the one or more blades.

13. The mixing assembly of claim 1, further comprising a second switch for controlling the motor, wherein the motor is activated when both the switch and the second switch are actuated.

14. The mixing assembly of claim 13, wherein the second switch is actuated by rotation of at least a portion of the housing.

15. The mixing assembly of claim 1, wherein the hole in the lid is sized to accommodate the passage of drink powders, pudding mixes, whipped topping, and sprinkles.

16. The mixing assembly of claim 1, wherein the housing comprises at least a first end, wherein the first end is configured to interface with the hole in the lid, wherein the power source is disposed within the housing proximate the first end.

17. A mixing assembly comprising:
a housing;
a motor disposed within the housing;
a pressure switch for controlling the motor, the switch disposed on a lower end of the housing; and
a mixing attachment directly or indirectly attached to the motor, the mixing attachment comprising at least one agitator;
wherein the agitator is designed and dimensioned to be inserted into a container through a hole in a lid of the container, and to facilitate easy removal of the mixing assembly from the container through the hole;
wherein the mixing attachment is configured to substantially reduce the risk of damage to the agitator when the mixing assembly is removed from the container.

18. The mixing assembly of claim 17, further comprising a second switch for controlling the motor, wherein the motor is activated when both the pressure switch and the second switch are actuated.

19. A mixer kit, comprising:
a mixing assembly as recited in claim 1;
a container and a lid for the container, the lid comprising a hole;
a straw adapter, the straw adapter configured to fit into the hole of the lid of the container, the straw adapter comprising a centrally located hole sized to fit a conventional straw; and
a measuring spoon sized to fit into the hole of the lid of the container to deposit measured powder or liquid portions.

20. The mixer kit of claim 19, further comprising molds into which a drink prepared with the mixer kit may be poured for freezing.
